(19) United States
(12) Patent Application Publication
(10) Pub. No.: US 2022/0203941 A1
(43) Pub. Date: Jun. 30, 2022

(54) Rotary air pipe and inflator

(71) Applicant: Dongguan Jisheng Automation Equipment Technology Co., Ltd, Dongguan City (CN)

(72) Inventors: Chaobing Luo, Dongguan City (CN); Yongde Hu, Dongguan City (CN)

(21) Appl. No.: 17/159,164

(22) Filed: Jan. 27, 2021

(30) Foreign Application Priority Data
Dec. 31, 2020 (CN) 202023350418.5

(51) Int. Cl. B60S 5/04; F04B 35/04; F04B 53/14; F16L 27/08

(52) U.S. Cl. CPC B60S 5/046; F16L 27/08; F04B 53/144; F04B 35/04

(57) ABSTRACT

A rotary air pipe connecting an air outlet of an inflator includes a pipe body, a sleeve with an inner wall and an outer wall, and a first sealing ring. The pipe body has main body and a bottom portion, a top of the main body is provided with a joint, a bottom portion has a front portion and a back portion. The bottom portion passes through the sleeve, the front portion fits the inner wall of the sleeve, the back portion extends out of the sleeve. The bottom portion can rotate around an axial direction of the pipe body in the sleeve; the bottom surface of the sleeve is provided with a thread connecting with the front wall. The back portion is movably inserted into the air outlet, the first sealing ring is sleeved with the back portion, the first sealing ring fits the back wall.

### FIELD OF THE INVENTION

The present invention involves inflator technical fields, more particularly, to a rotary air pipe and an inflator.

### BACKGROUND OF THE INVENTION

Tyre inflator in automobile is an appliance used for inflating tires with the vehicle power supply. Chinese patent CN201520396451.1 discloses a new protective electric inflator which includes a shell and a motor fixed in the shell. The front of the motor is arranged with a cylinder assembly, which is connected with an air pipe assembly. The air pipe assembly is provided with an air pipe. In the prior art, the air pipe is connected with the nozzle of the inflating tires through the air pipe nozzle. Because the air pipe is fixed, it can not move. However in actual use, when the automobile stops, the orientation of the nozzle of the inflating tires is random. If the orientation of the nozzle of the inflating tires is not convenient for the connection of the nozzle of the air pipe, it is necessary to twist the air pipe. However, the air pipe is generally made of very tough rubber, it is difficult to twist and very inconvenient to use.

### SUMMARY OF THE INVENTION

The objection of the present invention is to provide a rotary air pipe and an inflator with the rotary air pipe to solve the technical problems that the air pipe of the inflator in the prior art is fixed, it can not rotate, and it is not convenient to use.

In order to achieve the objection, the present invention provide a rotary air pipe, which connects an air outlet of an inflator. The air outlet has a front wall and a back wall; the rotary air pipe includes a pipe body, a sleeve with an inner wall and an outer wall, and a first sealing ring.

The pipe body has main body and a bottom portion at a bottom of the main body, a top of the main body is provided with a joint. The bottom portion has a front portion and a back portion.

The bottom portion passes through the sleeve, the front portion fits the inner wall of the sleeve, the back portion extends out of the sleeve. The bottom portion can rotate around an axial direction of the pipe body in the sleeve; the bottom surface of the sleeve is provided with a thread, the thread is connected with the front wall.

The back portion is movably inserted into the air outlet, the first sealing ring is sleeved with the outer wall of the back portion, the first sealing ring fits the back wall.

Preferably, both of the main body and the bottom portion of the rotary air pipe are cylinder shape, the external diameter of the bottom portion is less than that of the main body.

Preferably, the outer wall of the back portion is provided with an annular groove, the first sealing ring is received in the annular groove.

Preferably, the first sealing ring protrudes the outer wall of the back portion, the first sealing ring is limited by the bottom surface of the sleeve.

The rotary air pipe in the present invention has the following advantages: The thread of the rotary air pipe is connected with the front wall, the sleeve is connected with the air outlet of the inflator by the way of screw connection, the bottom portion passes through the sleeve and can rotate around an axial direction of the pipe body in the sleeve. When the rotary pipe is used, the joint is connected with the nozzle of the inflating tires, and the rotary pipe can be rotated, which is convenient for the joint to connect with the nozzle of the inflating tires, and it has the advantages of easy use and simple structure.

The present invention also provided with the inflator having the above rotary air pipe.

The inflator includes a housing, a driving assembly and a dual-cylinder assembly.

The housing is a long cylinder with a mounting cavity, the mounting cavity is arranged in a straight line along the length direction of the housing. The mounting cavity is communicated with outside world and has a front cavity and a rear cavity.

The driving assembly is arranged in the rear cavity, the driving assembly includes a power controlling assembly and a motor, the motor is electrically connected with the power controlling assembly and the motor is located between the power controlling assembly and the dual-cylinder assembly.

The dual-cylinder assembly is arranged in the front cavity, the dual-cylinder assembly includes a frame, a transmission mechanism, two pistons and a two-cylinder body. The frame has a rear fixing surface and a front fixing surface. The motor has a shell. The rear fixing surface is fixed to the shell. The front fixing surface is fixed to the two-cylinder body. The transmission mechanism is received in the frame. The motor drives and connects the transmission mechanism, the transmission mechanism drives and connects the two pistons respectively. The two pistons are provided with an unidirectional structure respectively. The two-cylinder body has a first cylinder body, a second cylinder body and a cover. The two pistons are movable in the first cylinder body and the second cylinder body, respectively. The air outlet is arranged on the cover. The cover is also provided with a gas passage. A first unidirectional mechanism is arranged at the first cylinder body. A second unidirectional mechanism is arranged at the second cylinder body. The first unidirectional mechanism, the second unidirectional mechanism and the air outlet are all communicated with the gas passage.

The dual-cylinder assembly is arranged in the front cavity, the dual-cylinder assembly includes a frame, a transmission mechanism, two pistons and a two-cylinder body. The frame has a rear fixing surface and a front fixing surface. The motor has a shell. The rear fixing surface is fixed to the shell. The front fixing surface is fixed to the two-cylinder body. The transmission mechanism is received in the frame. The motor drives and connects the transmission mechanism, the transmission mechanism drives and connects the two pistons respectively. The two pistons are provided with an unidirectional structure respectively. The two-cylinder body has a first cylinder body, a second cylinder body and a cover. The two pistons are movable in the first cylinder body and the second cylinder body, respectively. The air outlet is arranged on the cover. The cover is also provided with a gas passage. A first unidirectional mechanism is arranged at the first cylinder body. A second unidirectional mechanism is arranged at the second cylinder body. The first unidirectional mechanism, the second unidirectional mechanism and the air outlet are all communicated with the gas passage.

Preferably, the frame includes a hollow frame and a spacer, A cavity is formed in the hollow frame. The front fixing surface and the rear fixing surface are arranged on the front side and rear side of the hollow frame, respectively. The rear fixing surface is provided with a through hole. The spacer is fixed to a third inner surface in the cavity and divide the cavity into an upper cavity and a lower cavity. A circular hole is arranged on the spacer, and the through hole is communicate with the circular hole. The surface of the hollow frame is also evenly provided with at least two assembly slots. The inner wall of the housing is provided with convex strips matching the assembly slots.

Preferably, the transmission mechanism comprises a first bevel gear, a ring member, a second bevel gear and an eccentric wheel.

The axial direction of the first bevel gear is arranged along the length of the mounting cavity. The motor has a driving shaft, the first bevel gear is mounted on the driving shaft and passes through the through hole.

A ring limiting wall is arranged on the hole wall of the circular hole, and the ring member are deposed in circular hole and limited by the hole wall.

The axial direction of the second bevel gear is perpendicular to the axial direction of the first bevel gear, and the second bevel gear is meshed with the first bevel gear. A connecting shaft is arranged at the axis of the second bevel gear, the connecting shaft extends upward and passes through the ring member.

The eccentric wheel is arranged at the top of the connecting shaft and is received in the upper cavity.

Optionally, each of the two pistons comprises a piston rod, a head and a second sealing ring. The two piston rods are respectively eccentrically connected with the eccentric wheel and the second bevel gear. The two heads are respectively fixed at the front ends of the two piston rods. The two second sealing rings are sleeved on of the heads. Each of the unidirectional structure comprises an one-port and a C shrapnel. The one-port runs through the head along its thickness direction. The front end of the head is provided with a slot. The C shrapnel is closely received in the slot, and the two end of the C shrapnel is fixed with the front end of the head. The middle part of the C shrapnel covers the one-port. Both of the first cylinder body and the second cylinder body are circular cylinders with that one end is provided with a cylinder inlet, the other end is provided with a cylinder outlet. The two piston rods, are respectively extended out of the two cylinder inlet, and the two piston rods closely fits with the second inner wall of the first cylinder body and the second cylinder body, respectively. The first unidirectional mechanism and the second unidirectional mechanism respectively comprises a spring and a sealing plug. The cover is provided with the one-ports which are respectively corresponding to the two cylinder outlet and are communicated with the gas channel . One end of the spring is limited on the top end of the one-ports, the other end of the spring is connected with the sealing plug. The spring presses the sealing plug in the cylinder outlet.

Optionally, the power controlling assembly includes a battery module, one PCB plate and one controlling key. Both poles of the battery module are respectively connected with the PCB plate by connecting terminal, and the controlling key is exposed on the housing.

The inflator in the present invention has the following advantages: When the rotary air pipe of the inflator is used, the joint is connected with the tire nozzle and the rotary air pipe is rotated, so it is convenient for the joint to connect with the tire nozzle, and it has the advantages of easy use and simple structure.

In order to explain more clearly the technical scheme in the embodiment of the present invention, a brief introduction is given below to the attached drawings needed in the embodiment or the prior art description. Obviously, the attached drawings in the following description are only some embodiments of the invention.

### BRIEF DESCRIPTION OF THE DRAWINGS

FIG. 1 shows the front view of rotating air pipe according to the present invention.

FIG. 2 shows a section view of FIG. 1 along the A-A line according to the present invention.

FIG. 3 shows an enlarge view of the B region in FIG. 3

FIG. 4 shows the front view of the inflator 100 according to the present invention.

FIG. 5 shows a section view of FIG. 4 along the C-C line according to the present invention.

FIG. 6 shows an enlarge view of the D region in FIG. 5.

FIG. 7 shows an enlarge view of the E region in FIG. 5.

FIG. 8 shows a decomposition view of the inflator 100 according to the present invention.

FIG. 9 shows a perspective view of the motor 150, the transmission mechanism 170 and the piston 180 according to the present invention.

FIG. 10 shows a perspective view of the frame 160 according to the present invention.

### DETAILED DESCRIPTION OF ILLUSTRATED EMBODIMENTS

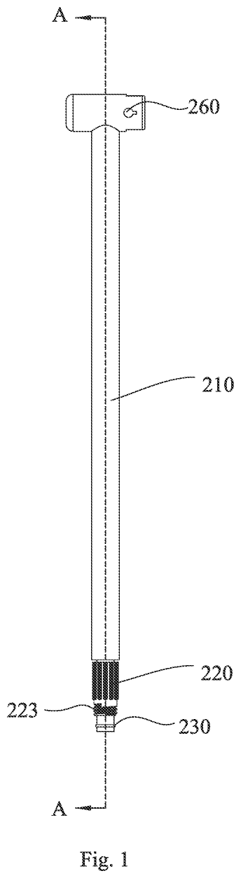

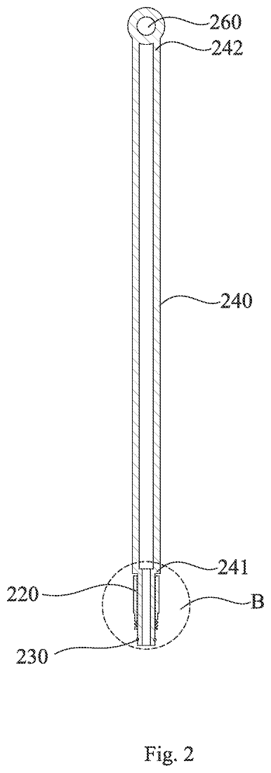

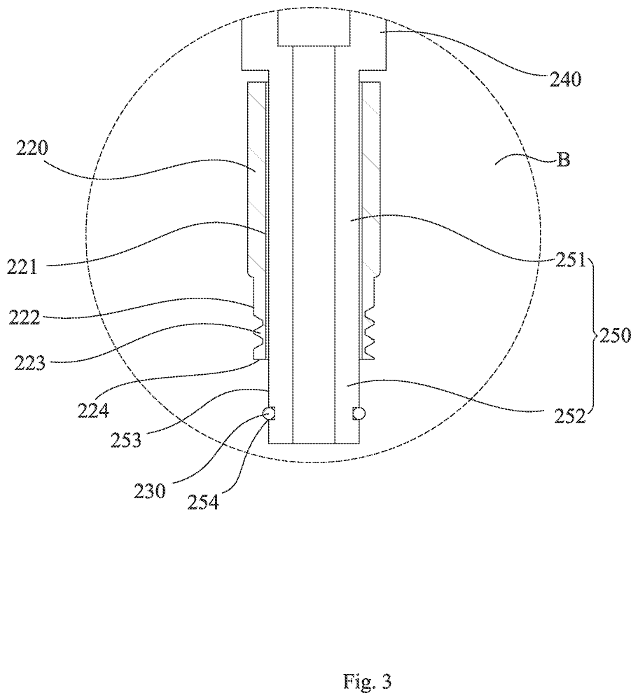

Referring to FIG. 1-6, the present invention discloses a rotary air pipe 200 connected to an air outlet 194 of an inflator 100. The air outlet 194 has a front wall 1941 and a back wall 1942. Referring to FIG. 1, FIG. 2 and FIG. 3, the rotary air pipe 200 includes a pipe body 210, a sleeve 220 with inner wall 221 and outer wall 222, and a first sealing ring 230. The pipe body 210 has main body 240 and a bottom portion 250 at the bottom 241 of the main body 240, the top 242 of the main body 240 is provided with a joint 260. The bottom portion 250 has a front portion 251 and a back portion 252, the bottom portion 250 passes through the sleeve 220, the front portion 251 fits the inner wall 221 of the sleeve 220, the back portion 252 extends out of the sleeve 220. The bottom portion 250 can rotate around the axial direction of the pipe body 210 in the sleeve 220.

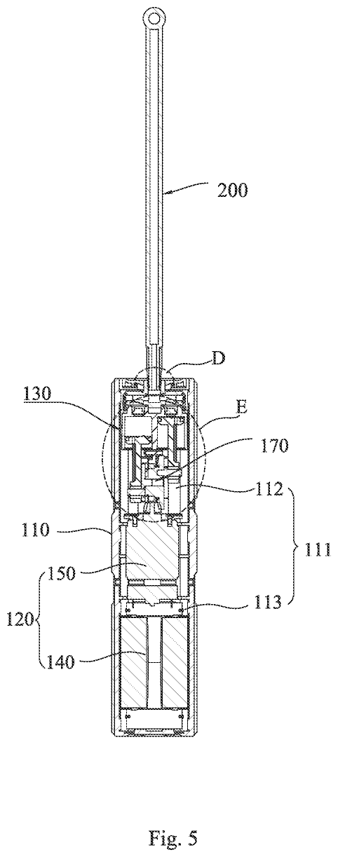

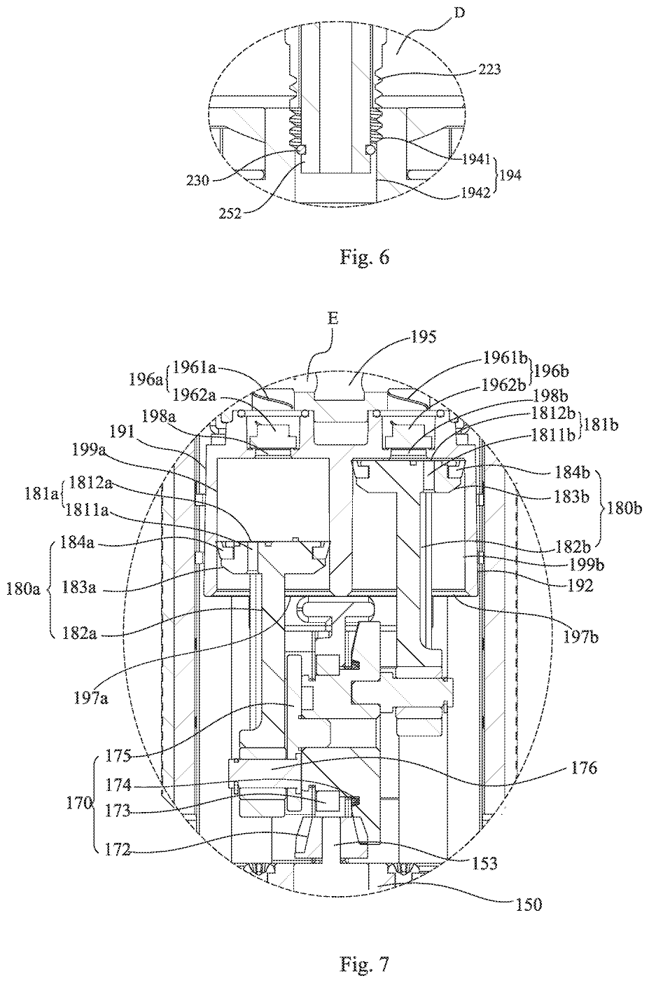

Concretely, the main body 240 and the bottom portion 250 are integrated molding, when the bottom portion 250 is rotated, the whole pipe body 210 is rotated. Referring to FIG. 5 and FIG. 6, a bottom surface 222 of the sleeve 220 is provided with a thread 223, the thread 223 is connected with the front wall 1941 of the air outlet 194. The back portion 252 is movably inserted into the air outlet 194. The first sealing ring 230 is sleeved with the outer wall 253 of the back portion 252. The first sealing ring 230 fits the back wall 1942. Concretely, only when the thread 223 is totally connected with the front wall 1941 and the back portion 252 is totally inserted into the air outlet 194, the first sealing ring 230 can fit the back wall 1942. The first sealing ring 230 plays a role of sealing, and when the bottom portion 250 is rotated, the first sealing ring 230 has damping action.

The sleeve 220 of the rotary air pipe 200 is screwed to the air outlet 194 of the inflator 100, the bottom portion 250 passes through the sleeve 220 and can rotate around the axial direction of the pipe body 210 in the sleeve 220. When the rotary air pipe 200 is used, the joint 260 is connected with an nozzle of an inflating tires. The rotary air pipe 200 can be rotated thus facilitating the connection of the joint 260 to the nozzle of the inflating tires, it has the advantages of easy use and simple structure.

In another embodiments in the present invention, referring to FIG. 2 and FIG. 3, both of the main body 240 and the bottom portion 250 of the rotary air pipe 200 are cylinder shape. The external diameter of the bottom portion 250 is less than that of the main body 240. The bottom portion 250 is provided with the sleeve 220, the external diameter of the sleeve 220 is approximately the same as the external diameter of the main body 240.

In another embodiments in the present invention, referring to FIG. 3, the outer wall 253 of the back portion 252 is provided with an annular groove 254, the first sealing ring 230 is partly received in the annular groove 254. The annular groove 254 is used for defining the first sealing ring 230.

In another embodiments in the present invention, referring to FIG. 3, the first sealing ring 230 protrudes the outer wall 253 of the back portion 252, the first sealing ring 230 is limited by the bottom surface 224 of the sleeve 220, thereby preventing the bottom portion 250 from taking off the sleeve 220.

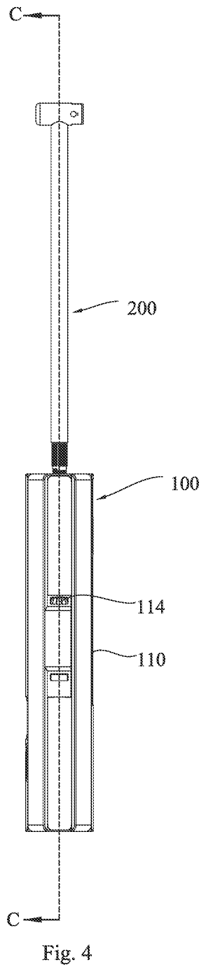

In another embodiments in the present invention, referring to FIG. 4, the present invention also provides an inflator 100, which includes the above rotary air pipe 200.

In another embodiments in the present invention, referring to FIG. 4-10, the inflator 100 also includes a housing 110, a driving assembly 120 and a dual-cylinder assembly 130.

Referring to FIG. 4 and FIG. 5, the housing 110 is a long cylinder with a mounting cavity 111, the mounting cavity 111 is arranged in a straight line along the length direction of the housing 110. The mounting cavity 111 is communicated with the outside world and has a front cavity 112 and a rear cavity 113. Concretely, the housing 110 is preferably a plastic housing, the surface of which is provided with breathable holes 114, through which the mounting cavity 111 is communicated with the outside world.

The driving assembly 120 is arranged in the rear cavity 113, the driving assembly 120 includes a power controlling assembly 140 and a motor 150, the motor 150 is electrically connected with the power controlling assembly 140 and the motor 150 is located between the power controlling assembly 140 and the dual-cylinder assembly 130.

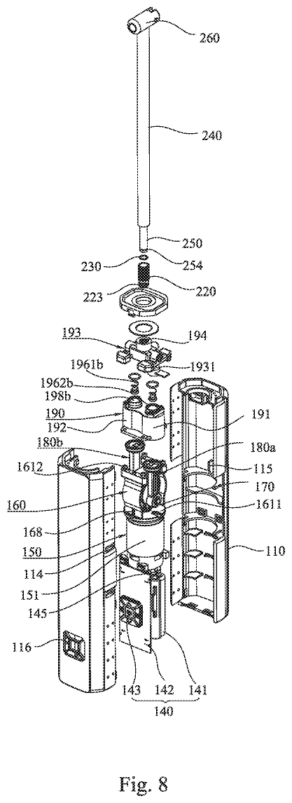

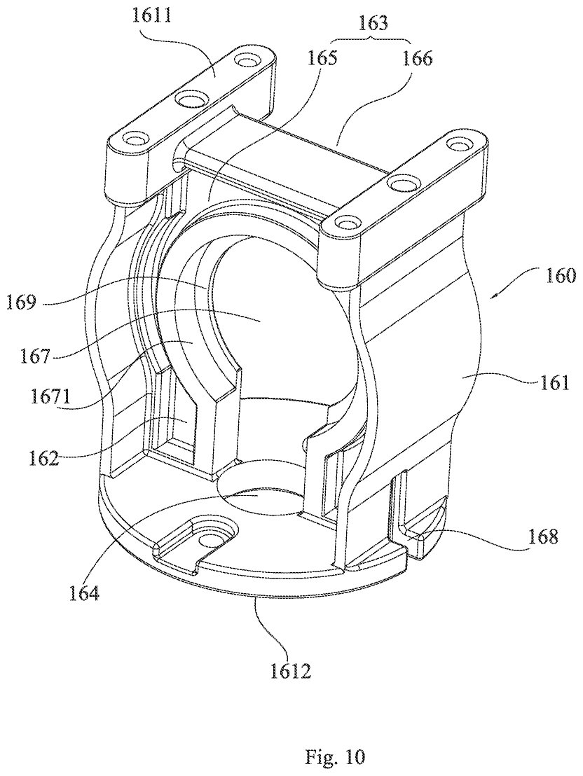

Referring to FIG. 7 and FIG. 8, the dual-cylinder assembly 130 is arranged in the front cavity 112, the dual-cylinder assembly 130 includes a frame 160, a transmission mechanism 170, two pistons 180a,180b and a two-cylinder body 190. Referring to FIG. 8 and FIG. 10, the frame 160 has a rear fixing surface 1611 and a front fixing surface 1612. The motor 150 has a shell 151. The rear fixing surface 1611 is fixed to the shell 151. The front fixing surface 1612 is fixed to the two-cylinder body 190. The transmission mechanism 170 is received in the frame 160. The motor 150 drives and connects the transmission mechanism 170, the transmission mechanism 170 drives and connects the two pistons 180a,180b respectively. The two pistons 180a,180b are provided with an unidirectional structure 181a, 181b respectively. The two-cylinder body 190 has a first cylinder body 191, a second cylinder body 192 and a cover 193. The two pistons 180a,180b are respectively movably arranged in the first cylinder body 191 and the second cylinder body 192. The air outlet 194 is arranged on the cover 193. The cover 193 is also provided with a gas passage 195. A first unidirectional mechanism 196a is arranged at the front end of the first cylinder body 191. A second unidirectional mechanism 196b is arranged at the front end of the second cylinder body 192. The first unidirectional mechanism 196a, the second unidirectional mechanism 196b and the air outlet 194 are all communicate with the gas passage 195.

When the inflator 100 works, the motor 150 drives the two pistons 180a, 180b through the transmission mechanism 170 to alternately move forward and backward. Taking the piston 180a arranged in the first cylinder body 191 as an example, the working principle of the piston 180a is illustrated as follows: When the piston 180a move backward, the unidirectional structure 181a is opened, the first cylinder body 191 inhales gas, at this time, the first unidirectional mechanism 196a, the second unidirectional mechanism 196b are closed. When the piston 180a moves forward, the unidirectional structure 181a is closed, at this time, the first unidirectional mechanism 196a is opened, the gas enters the gas passage 195 and then be compressed therein. The compressed gas in the gas passage 195 enters the rotary air pipe 200 through the air outlet hole 194.

The inflator 100 has the following advantages:

When the rotary air pipe 200 in the inflator 100 is used, the joint 260 is connected with the nozzle of the inflating tires. The rotary air pipe 200 is rotated so that it is convenient for the joint 260 to connect with the nozzle of the inflating tires, and it has the advantages of easy use and simple structure.

The inflator 100 is a linear structure, and the mounting cavity 111 is arranged in a straight line along the length direction of the housing 110. The driving assembly 120 is arranged in the rear cavity 113, and the dual-cylinder assembly 130 is arranged in the front cavity 112. The long strip housing 110 is more convenient to hold.

The inflator 100 uses the dual-cylinder assembly 130 to pump gas, the two piston 180a. 180b works at the same time to alternatively pump gas. It improves the efficiency of inhaling gas.

In another example in the present invention, referring to FIG. 10, the frame 160 in the inflator 100 includes a hollow frame 161 and a spacer 162, A cavity 163 is formed in the hollow frame 161. The front fixing surface 1612 and the rear fixing surface 1611 are arranged on the front side and rear side of the hollow frame 161, respectively. The rear fixing surface 1612 is provided with a through hole 164. The spacer 162 is fixed to a third inner surface 1631 in the cavity 163 and divide the cavity 163 into an upper cavity 165 and a lower cavity 166. A circular hole 167 is arranged on the spacer 162, and the through hole 164 is communicate with the circular hole 167. The surface of the hollow frame 161 is also evenly provided with at least two assembly slots 168. The inner wall of the housing 110 is provided with at least two convex strips 115 matching the assembly slots 168. The convex strips 115 and the assembly slots 168 are cooperated, which simple the assembly steps. The frame 160 plays the function of supporting and bearing the two pistons 180a, 180b through the transmission mechanism 170, it also enhances the structural strength of the inflator 100.

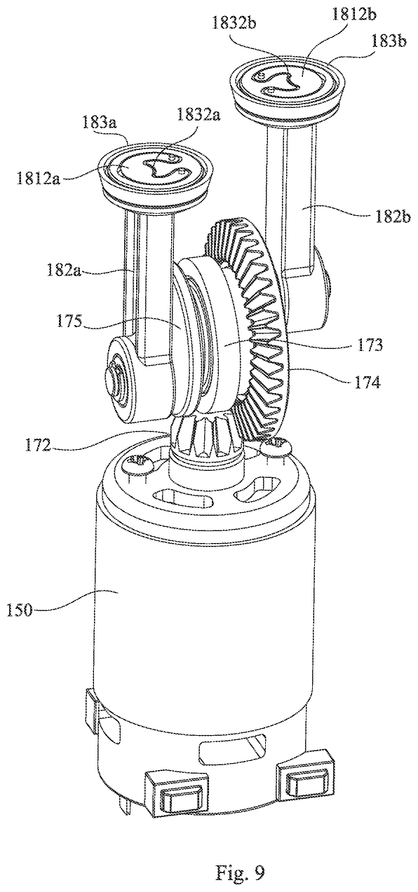

In another example in the present invention, referring to FIG. 9 and FIG. 10, the transmission mechanism 170 comprises a first bevel gear 172, a ring member 173, a second bevel gear 174 and an eccentric wheel 175. The axial direction of the first bevel gear 172 is arranged along the length of the mounting cavity 111. The motor 150 has a driving shaft 153, the first bevel gear 172 is mounted on the driving shaft 153 and passes through the through hole 164. A ring limiting wall 169 is arranged on the hole wall 1671 of the circular hole 167, and the ring member 173 are deposed in circular hole 167 and limited by the hole wall 1671. The axial direction of the second bevel gear 174 is perpendicular to the axial direction of the first bevel gear 172, and the second bevel gear 174 is meshed with the first bevel gear 172. The second bevel gear 174 is provided with a connecting shaft 176, which extends upward and passes through the ring member 173. The eccentric wheel 175 is arranged at the top of the connecting shaft 176 and is received in the upper cavity 165.

The working principle of the transmission mechanism 170 is as follows: the motor 150 drives the first bevel gear 172 to rotate, the first bevel gear 172 drives the second bevel gear 174 to rotate, and the second bevel gear 174 drives the eccentric wheel 175 to rotate. The transmission mechanism 170 is capable of converting rotational motion into linear motion. The transmission mechanism 170 is capable of distributing the power from one power input source, that is the motor 150, to two power outputs, that are the second bevel gear 174 and the eccentric wheel 175.

In another example in the present invention, referring to FIG. 7, each of the two pistons 180a, 180b comprises a piston rod 182a,182b, a head 183a,183b and a second sealing ring 184a,184b. The two piston rods 182a and 182b are respectively eccentrically connected with the eccentric wheel 175 and the second bevel gear 174. The two heads 183a and 183b are respectively fixed on the two piston rods 182a and 182b. The two second sealing rings 184a,184b are sleeved on the heads 183a and 183b.

Referring to FIG. 7 and FIG. 9, the unidirectional structure 181a, 181b comprises an one-port 1811a, 1811b and a C shrapnel 1812a,1812b, respectively. The one-port 1811a,1811b runs through the head 183a,183b respectively along its thickness direction. The front end of the head 183a,183b is provided with a slot 1832a,1832b. The C shrapnel 1812a,1812b is closely received in the slot 1832a,1832b, and two end of the C shrapnel 1812a,1812b are fixed at the head 183a,183b. The middle part of the C shrapnel 1812a,1812b covers the one-port 1811a,1811b.

Both of the first cylinder body 191 and the second cylinder body 192 are circular cylinders with that one end is provided with a cylinder inlet 197a, 197b, the other end is provided with a cylinder outlet 198a, 198b. The two piston rods 182a, 182b, are respectively extended out of the two cylinder inlet 197a,197b, and the two piston rods 182a, 182b, closely fits with the second inner wall 199a,199b of the first cylinder body 191 and the second cylinder body 192, respectively.

The first unidirectional mechanism 196a and the second unidirectional mechanism 196b respectively comprises a spring 1961a,1961b and a sealing plug 1962a,1962b. The cover 193 is provided with the one-ports 1811a and 1811b which are respectively corresponding to the two cylinder outlet 198a, 198b and are communicated with the gas channel 195. One end of the spring 1961a , 1961b is limited on the top end of the one-ports 1811a and 1811, the other end of the spring 1961a, 1961b is connected with the sealing plug 1962a, 1962b. The spring 1961a, 1961b presses the sealing plug 1962a, 1962b in the cylinder outlet 198a, 198b.

The motor 150 drives the second bevel gear 174 to rotate, the second bevel gear 174 drives the eccentric wheel 175 to rotate, the eccentric wheel 175 drives the two piston rod 182a,182b to move forward and backward. The two head 183a, 183b alternately move forward and backward in the first cylinder body 191 and the second cylinder body 192, respectively. Taking the head 183a in the first cylinder body 191 as example, the working principle of the piston 180a is illustrated as follows: When the head 183a moves backward, a negative pressure is formed in the first cylinder body 191, the external gas pushes the C shrapnel 1812a and enters the first cylinder body 191 from the air hole 1811a. At this time, the spring 1961a presses the sealing plug 1962a in the cylinder outlet 198a of the first cylinder body 191.

When the head 183a moves forward, the gas in the first cylinder body 191 is compressed into high pressure gas. Because of the pressure difference, the the C shrapnel 1812a resets and covers the one-ports 1811a, while the spring 1961a is compressed, the sealing plug 1962a is away from the cylinder outlet 198a. The high pressure gas enters the gas passage 195 from the cylinder outlet 198a. The above process is a complete pumping process. The process is repeated so that continuous pump gas can be realized.

In another example in the present invention, referring to FIG. 8, the cover 193 is provided with a pressure sensing module 1931 which is communicated with the gas passage 195. Concretely, the pressure sensing module 1931 is a pressure sensor, and the measured pressure value is displayed through a display screen (not shown). The display screen can be arranged in an appropriate position on the surface of the housing 110.

In another example in the present invention, the pistons 180a, 180b in inflator 100 have unidirectional intake function and are not limited to the above structure. The pistons 180a, 180b may also be the piston rod disclosed in CN202010041850.1, or the piston assembly disclosed in U.S. Pat. No. 9,115,807.

In another example in the present invention, referring to FIG. 8, the power controlling assembly 140 includes a battery module 141, one PCB plate 142 and one controlling key 143. Both poles of the battery module 141 are respectively connected with the PCB plate 142 by connecting terminal 145, and the controlling key 143 is exposed on the housing 110. Concretely, the housing 110 is provided with a key hole 116 matched with the controlling key 143 the controlling key 143 is connected with the PCB plate 142. The purpose of the above design is to reduce the use of wires and further simplify the circuit structure.

The above is only a better embodiment of the present invention and is not used to limit the present invention. Any modification, equivalent replacement and improvement made within the spirit and principles of the present invention shall be included in the protection scope of the present invention.

What is claimed is:

1. A rotary air pipe, connecting with an air outlet of an inflator, said air outlet has a front wall and a back wall; wherein said rotary air pipe comprising:
a pipe body, said pipe body has main body and a bottom portion at a bottom of said main body, a top of said main body is provided with a joint, said bottom portion has a front portion and a back portion;
a sleeve with an inner wall and an outer wall, said bottom portion passes through said sleeve; said front portion fits said inner wall of said sleeve, said back portion extends out of said sleeve, said bottom portion can rotate around an axial direction of said pipe body in said sleeve; a bottom surface of said sleeve is provided with a thread, said thread is connected with said front wall; and,
a first sealing ring, said back portion is movably inserted into said air outlet, said first sealing ring is sleeved with an outer wall of said back portion, said first sealing ring fits said back wall.

2. The rotary air pipe according to claim 1, wherein said main body and said bottom portion are cylinder shape, said external diameter of said bottom portion is less than that of said main body.

3. The rotary air pipe according to claim 1, wherein said outer wall of said back portion is provided with an annular groove, said first sealing ring is received in said annular groove.

4. The rotary air pipe according to claim 1, wherein said first sealing ring protrudes said outer wall of said back portion, said first sealing ring is limited by a bottom surface of said sleeve.

5. The rotary air pipe according to claim 2, wherein said first sealing ring protrudes said outer wall of said back portion, said first sealing ring is limited by said bottom surface of said sleeve.

6. The rotary air pipe according to claim 3, wherein said first sealing ring protrudes said outer wall of said back portion, said first sealing ring is limited by said bottom surface of said sleeve.

7. An inflator, having an air outlet, said air outlet has a front wall and a back wall, wherein comprising a rotary air pipe connecting with said air outlet; said rotary air pipe comprising:
a pipe body, said pipe body has main body and a bottom portion at a bottom of said main body, a top of said main body is provided with a joint, said bottom portion has a front portion and a back portion;
a sleeve with an inner wall and an outer wall, said bottom portion passes through said sleeve; said front portion fits said inner wall of said sleeve, said back portion extends out of said sleeve, said bottom portion can rotate around an axial direction of said pipe body in said sleeve; a bottom surface of said sleeve is provided with a thread, said thread is connected with said front wall; and,
a first sealing ring, said back portion is movably inserted into said air outlet, said first sealing ring is sleeved with an outer wall of said back portion, said first sealing ring fits said back wall.

8. The inflator according to claim 6, wherein also comprising:
a housing, said housing is a long cylinder with a mounting cavity, said mounting cavity is arranged in a straight line along said length direction of said housing; said mounting cavity is communicated with said outside world and has a front cavity and a rear cavity;
a driving assembly, said driving assembly is arranged in said rear cavity, said driving assembly includes a power controlling assembly and a motor, said motor is electrically connected with said power controlling assembly and said motor is located on said front side of said power controlling assembly; and,
a dual-cylinder assembly, said dual-cylinder assembly is arranged in said front cavity, said dual-cylinder assembly includes a frame, a transmission mechanism, two pistons and a two-cylinder body; said frame has a rear fixing surface and a front fixing surface; said motor has a shell, said rear fixing surface is fixed to said shell, said front fixing surface is fixed to said two-cylinder body; said transmission mechanism is received in said frame, said motor drives and connects said transmission mechanism, said transmission mechanism drives and connects said two pistons respectively; two said pistons are provided with an unidirectional structure respectively; said two-cylinder body has a first cylinder body, a second cylinder body and a cover; two said pistons are respectively movable in said first cylinder body and said second cylinder body; said air outlet is arranged on said cover; said cover is also provided with a gas passage; a first unidirectional mechanism is arranged at said first cylinder body, a second unidirectional mechanism is arranged at said second cylinder body; said first unidirectional mechanism, said second unidirectional mechanism and said air outlet are all communicated with said gas passage.

9. The inflator according to claim 8, wherein said frame includes a hollow frame and a spacer, a cavity is formed in said hollow frame; said front fixing surface and said rear fixing surface are arranged on said front side and rear side of said hollow frame, respectively; said rear fixing surface is provided with a through hole. said spacer is fixed to a third inner surface in said cavity and divide said cavity into an upper cavity and a lower cavity; a circular hole is arranged on said spacer, and said through hole is communicate with said circular hole; said surface of said hollow frame is also evenly provided with assembly slots, said inner wall of said housing is provided with convex strips matching said assembly slots.

10. The inflator according to claim 9, wherein said transmission mechanism comprising:
a first bevel gear, an axial direction of said first bevel gear is arranged along said length of said mounting cavity; said motor has a driving shaft, said first bevel gear is mounted on said driving shaft and passes through said through hole;
a ring member, a ring limiting wall is arranged on an hole wall of said circular hole, and said ring member are deposed in circular hole and limited by said hole wall;
a second bevel gear, an axial direction of said second bevel gear is perpendicular to said axial direction of said first bevel gear, and said second bevel gear is meshed with said first bevel gear; a connecting shaft is arranged at an axis of said second bevel gear, said connecting shaft extends upward and passes through said ring member; and,
an eccentric wheel, said eccentric wheel is arranged at said top of said connecting shaft and is received in said upper cavity.

11. The inflator according to claim 10, wherein each of said two pistons comprises a piston rod, a head and a second sealing ring; said two piston rods are respectively eccentrically connected with said eccentric wheel and said second bevel gear; said two heads are respectively fixed at said front ends of said two piston rods; said two second sealing rings are sleeved on said heads; each of said unidirectional structure comprises a one-port and a C shrapnel, said one-port runs through said head along its thickness direction, said head is provided with a slot; said C shrapnel is closely received in said slot, and two ends of said C shrapnel is fixed in said head; said middle part of said C shrapnel covers said one-port; said first cylinder body and said second cylinder body are circular cylinders with that one end is provided with a cylinder inlet, the other end is provided with a cylinder outlet; said two piston rods are respectively extended out of said two cylinder inlet, and said two piston rods closely fits with said second inner wall of said first cylinder body and said second cylinder body, respectively; said first unidirectional mechanism and said second unidirectional mechanism respectively comprises a spring and a sealing plug; said cover is provided with said one-ports which are respectively corresponding to said two cylinder outlet and are communicated with said gas channel; one end of said spring is limited on said top end of said one-ports, said other end of said spring is connected with said sealing plug; said spring presses said sealing plug in said cylinder outlet.

12. The inflator according to claim 9, wherein said power controlling assembly includes a battery module, one PCB plate and one controlling key; both poles of said battery module are respectively connected with said PCB plate by connecting terminal, and said controlling key is exposed on said housing.

13. The inflator according to claim 10, wherein said power controlling assembly includes a battery module, one PCB plate and one controlling key; both poles of said battery module are respectively connected with said PCB plate by connecting terminal, and said controlling key is exposed on said housing.

14. The inflator according to claim 11, wherein said power controlling assembly includes a battery module, one PCB plate and one controlling key; both poles of said battery module are respectively connected with said PCB plate by connecting terminal, and said controlling key is exposed on said housing.
